(19) United States
(12) Patent Application Publication
(10) Pub. No.: US 2007/0063084 A1
(43) Pub. Date: Mar. 22, 2007

(54) Cutter blade for shredder

(76) Inventor: Janice New, Taipei City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/274,274

(22) Filed: Nov. 16, 2005

(30) Foreign Application Priority Data
Sep. 20, 2005 (CN) 200520105354.9

(51) Int. Cl. B02C 18/18

(52) U.S. Cl. 241/295

(57) ABSTRACT

A shredding cutter blade for a shredding machine includes a main body having a serrated periphery and a locating hole for insertion of a rotatable shaft of the shredding machine, and two extension portions symmetrically obliquely extending from the serrated periphery of the main body and having respectively a cutting edge for cutting waste strips of paper shredded by the serrated periphery into small pieces.

### BACKGROUND OF THE INVENTION

1. Field of the Invention

The present invention relates to a shredding machine and more particularly, to a shredding cutter for a shredding machine.

2. Description of the Related Art

When wishing to destruct confidential paper documents, a shredding machine may be used to cut paper documents into strips.

A conventional shredding machine uses a plurality of shredding cutter blades for cutting sheets of paper into strips. These shredding cutter blades are metal cutting blades rotatable with shafts. When a sheet of paper is fed into the space between two reversely rotated sets of shredding cutter blades, the rotating shredding cutter blades cut the fed sheet of paper into strips. However, the shredded strips of paper may be reassembled so that an evil person can see the content of the original sheet of paper.

There is known a shredding machine of which each shredding cutter blade has an additional protruding portion that defines a shredding cutting edge and a cut-off cutting edge. This design of shredding machine is capable of shredding a sheet of paper into strips and at the same time cutting the shredded strips into pieces. According to this design, each shredding cutter blade must have a certain thickness so that the protruding portion can be formed. Because the shredding cutter blades are respectively made of a thick metal plat, the manufacturing cost of the shredding cutter blades is high. Further, the cutting effect of this design of shredding machine is still not satisfactory, i.e., the shredding cutter blades cannot cut a sheet of paper into very small chips.

### SUMMARY OF THE INVENTION

The present invention has been accomplished under the circumstances in view. It is one objective of the present invention to provide a shredding cutter assembly for shredding machine, which effectively shreds sheets of paper into small pieces.

It is another objective of the present invention to provide a shredding cutter assembly for shredding machine, which has a simple structure and a low manufacturing cost.

To achieve these objects of the present invention, the shredding cutter blade for the shredding cutter assembly comprises a main body having a serrated periphery, and two extension portions symmetrically obliquely extending from the serrated periphery and having respectively a cutting edge for cutting waste strips of paper shredded by the serrated periphery of the main into small pieces.

### BRIEF DESCRIPTION OF THE DRAWINGS

FIG. 1 is a front view of a shredding cutter blade according to the present invention.

FIG. 2 is a side view of the shredding cutter blade according to the present invention.

FIG. 3 is a schematic drawing showing a shredding cutter assembly constructed according to the present invention.

### DETAILED DESCRIPTION OF THE INVENTION

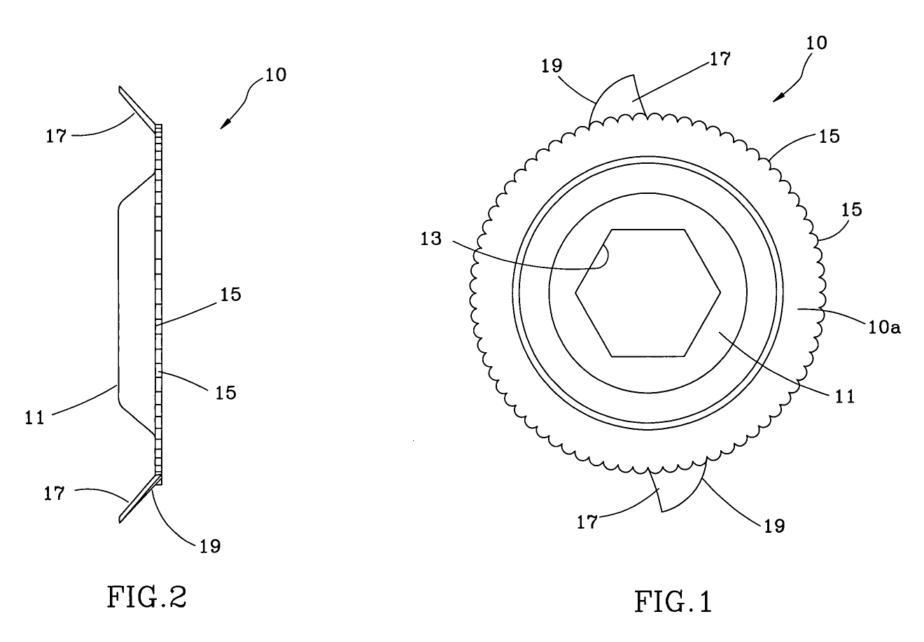

Referring to FIGS. 1 and 2, a shredding cutter blade 10 in accordance with the present invention is shown stamped from a metal plate, having a circle-like main body 10a, a protruded spacer portion 11 at a center portion of the main body 10a, a hexagonal locating hole 13 at the center portion of the spacer portion 11, serrated portions 15 arranged around the periphery of the main body 10a, and two extension portions 17 obliquely symmetrically extending from the periphery of the main body 10a at two opposite sides and protruding over a surface of the main body 10a. The extending direction of the extension portions 17 is substantially same as the protruding direction of the spacer portion 11. Further, each extension portion 17 has a cutting edge 19 at one side.

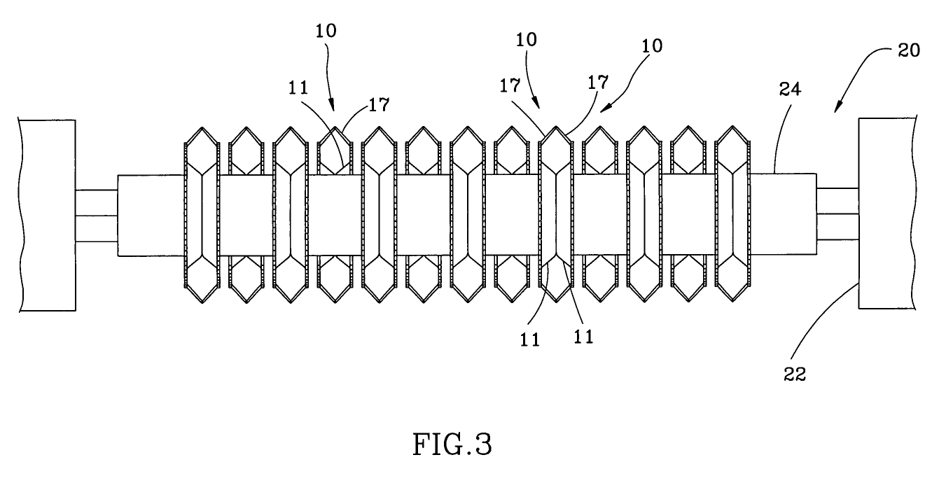

FIG. 3 shows a shredding cutter assembly 20 constructed according to the present invention. As illustrated, the shredding cutter assembly 20 comprises a rack 22, two shafts 24 pivotally mounted in the rack 22, and two sets of shredding cutter blades 10 respectively fixedly mounted on the shafts 24 and arranged in parallel at a predetermined pitch. Further, the shredding cutter blades 10 at each shaft 24 are arranged in pairs, and the two shredding cutter blades 10 of the same pair are arranged in reversed directions with the spacer portions 11 stopped against each other to keep the extension portions 17 of one shredding cutter blade 10 stopped against the extension portions 17 of the other shredding cutter blade 10. Further, shredding cutter blades 10 are alternatively arranged on the two shafts 24 in a staggered manner. When inserting a sheet of paper into the gap between the two shafts 24 during reverse rotation of the shafts 24, the sheet of paper will be shredded into narrow strips by the serrated portions 15 of the shredding cutter blades 10 and delivered downwards. At this time, the cutting edges 19 of the abutted extension portions 17 of each pair of shredding cutter blades 10 are forced to cut off the shredded strips of paper into small pieces.

As indicated above, by means of the extension portions of each shredding cutter blade, the invention can cut waste paper into small pieces with small thickness thereof Because the whole structure of the shredding cutter assembly is simple, the manufacturing cost is low.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A shredding cutter blade comprising:
a main body; and
at least one extension portion obliquely extending from a periphery of the main body and protruding over a surface of the main body, said extension portion having a cutting edge for cutting a strip member into pieces.

2. The shredding cutter blade as claimed in claim 1, wherein the main body has a protruded space portion protruding substantially along the extending direction of the extension portion.

3. The shredding cutter blade as claimed in claim 1, wherein the main body has a plurality of serrated portions arranged around the periphery thereof for cutting a sheet member into strips.

4. The shredding cutter blade as claimed in claim 1, wherein the main body has a center mounting hole for insertion of a shaft.

5. A shredding cutter assembly comprising:
a rack;
two shafts pivotally mounted in said rack and arranged in parallel; and
a plurality of shredding cutter blades arranged in pairs alternatively fixedly mounted on said shafts, said shredding cutter blades each having a main body with a locating hole for insertion one of the two shafts, and at least one extension portion obliquely extending from a periphery of the main body and having a cutting edge, the extension portion of one shredding cutter blade of each pair of shredding cutter blades being abutted against the extension portion of the other shredding cutter blade of the same pair of shredding cutter blades.

6. The shredding cutter assembly as claimed in claim 5, wherein the main body of each said shredding cutter blade has a protruded space portion protruding substantially along the extending direction of the extension portion.

7. The shredding cutter assembly as claimed in claim 5, wherein the main body of each said shredding cutter blade has a plurality of serrated portions arranged around the periphery thereof for cutting.
